(19) United States
(12) Patent Application Publication
(10) Pub. No.: US 2025/0294582 A1
(43) Pub. Date: Sep. 18, 2025

(54) METHODS AND APPARATUSES FOR SIDELINK FEEDBACK RESOURCE ALLOCATION

(71) Applicant: LENOVO (BEIJING) LIMITED, Beijing (CN)

(72) Inventors: Xiaodong Yu, Beijing (CN); Yu Zhang, Beijing (CN); Haipeng Lei, Beijing (CN); Zhennian Sun, Beijing (CN); Xin Guo, Beijing (CN)

(21) Appl. No.: 18/859,678

(22) PCT Filed: Apr. 24, 2022
(86) PCT No.: PCT/CN2022/088768

§ 371 Date: Oct. 24, 2024

(51) Int. Cl. H04W 72/25; H04L 5/00; H04W 72/0446

(52) U.S. Cl. CPC H04W 72/25; H04L 5/0055; H04W 72/0446

(57) ABSTRACT

Embodiments of the present application relate to methods and apparatuses for a sidelink feedback resource allocation mechanism on an unlicensed band. According to an embodiment of the present application, a user equipment (UE) includes a transceiver; and a processor coupled to the transceiver, wherein the processor is configured: to receive configuration information for a sidelink transmission on an unlicensed band via the transceiver from a network; to determine a feedback resource pattern on a feedback slot in response to a data transmission based on the configuration information; and to determine a set of feedback resources on the feedback slot based on the feedback resource pattern.

### TECHNICAL FIELD

Embodiments of the present disclosure are related to wireless communication technology, and more particularly, related to methods and apparatuses for a sidelink feedback resource allocation mechanism on an unlicensed band.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12 (i.e., Rel-12), and enables a direct communication between proximal UEs, and data does not need to go through a base station (BS) or a core network.

5G and/or new radio (NR) networks are expected to increase network throughput, coverage, and robustness and reduce latency and power consumption. With the development of 5G and NR networks, various aspects need to be studied and developed to perfect the 5G and/or NR technology. Currently, details regarding a sidelink feedback resource allocation mechanism on an unlicensed band have not been specified yet.

### SUMMARY

Some embodiments of the present application also provide a user equipment (UE). The UE includes a transceiver; and a processor coupled to the transceiver, wherein the processor is configured: to receive configuration information for a sidelink transmission on an unlicensed band via the transceiver from a network; to determine a feedback resource pattern on a feedback slot in response to a data transmission based on the configuration information; and to determine a set of feedback resources on the feedback slot based on the feedback resource pattern.

In some embodiments, the configuration information includes at least one of: an indicator for enabling or disabling a resource pool or a time slot to support or not support the feedback resource pattern; a bitmap sequence to represent a mapping relationship between the feedback resource pattern and a slot index; one feedback resource pattern for a resource pool or a time slot within the resource pool; or multiple feedback resource patterns for the resource pool or the time slot.

In some embodiments, in response to the configuration information including the multiple feedback resource patterns for the resource pool or the time slot, to determine the feedback resource pattern, the processor of the UE is configured to determine one feedback resource pattern within the multiple feedback resource patterns based on at least one of a traffic type or a cast type of the transmission slot, as the feedback resource pattern in response to the data transmission.

In some embodiments, the processor of the UE is configured to determine the feedback resource pattern based on a total number of group members, in response to a cast type of the data transmission being a groupcast with a feedback of negative acknowledgement (NACK) only, or a groupcast with a feedback of acknowledgement (ACK) or NACK.

In some embodiments, the processor of the UE is configured to transmit or receive sidelink control information (SCI) via the transceiver over a sidelink, wherein the SCI includes a cast type indicator or a feedback resource pattern type index, and wherein the cast type indicator or the feedback resource pattern type index indicates the feedback resource pattern.

In some embodiments, the processor of the UE is configured: to determine whether a cast type of the data transmission is a groupcast with a feedback of acknowledgement (ACK) or negative acknowledgement (NACK) based on the SCI; and in response to determine that the cast type of the data transmission is not the groupcast with a feedback of ACK or NACK, to not exclude remaining symbols in the feedback slot except the set of feedback resources for a second data transmission.

In some embodiments, the processor of the UE is configured: to determine whether a data transmission slot within a resource selection candidate resource set is monitored; and in response to determine that the data transmission slot is not monitored, to exclude both the data transmission slot and a feedback transmission slot associated with the data transmission slot for the data transmission.

In some embodiments, the processor of the UE is configured: to receive the data transmission via the transceiver over a sidelink; and to transmit hybrid automatic repeat request (HARQ) feedback information in response to a decoding state of the data transmission on the set of feedback resources via the transceiver over the sidelink.

In some embodiments, the processor of the UE is configured: to transmit the data transmission via the transceiver over a sidelink; and to receive HARQ feedback information in response to a decoding state of the data transmission on the set of feedback resources via the transceiver over the sidelink.

In some embodiments, the set of feedback resources is located in no more than five PSFCHs in the feedback slot.

In some embodiments, the processor of the UE is configured: to determine whether the set of feedback resources is with one to five physical sidelink feedback channels (PSFCHs), wherein each PSFCH within the one to five PSFCHs includes one symbol pair; in response to determining that the set of feedback resources is with one, two, or three PSFCHs, to exclude the one, two, or three PSFCHs within the feedback slot for a second data transmission; and in response to determining that the set of feedback resources is with four or five PSFCHs, to exclude the feedback slot for the second data transmission.

In some embodiments, the processor of the UE is configured to determine a cast type of the data transmission, and wherein the cast type is one of: a broadcast, a unicast, a groupcast with a feedback of negative acknowledgement (NACK) only, and a groupcast with a feedback of acknowledgement (ACK) or NACK.

In some embodiments, in response to determining that the set of feedback resources is with two or more PSFCHs and in response to the cast type of the data transmission being the unicast or the groupcast with the feedback of only NACK, feedbacks of data transmissions in two or more slots are located in different symbol pairs in the set of feedback resources.

In some embodiments, in response to the cast type of the data transmission being the unicast or the groupcast with the feedback of only NACK, and in response to the data transmission being located in multiple interlaces: a total number of slots between the data transmission and the feedback slot in a time domain is associated with a sidelink PSFCH period and a minimum time gap between the data transmission and the feedback slot configured to the UE; and an interlace of a feedback of the data transmission within the set of feedback resources is a lowest interlace within the multiple interlaces in a frequency domain.

In some embodiments, in response to the cast type of the data transmission being the groupcast with the feedback of ACK or NACK, the processor of the UE is configured: to determine a first total number of physical sidelink feedback channels (PSFCHs) within the set of feedback resources in the feedback slot; to determine a second total number of interlaces of the feedback slot; to compute a product of the first total number and the second total number; to determine a feedback resource within the set of feedback resources for a feedback of the data transmission based on the product and a member identity (ID) number of a UE transmitting the feedback of the data transmission.

In some embodiments, the second total number of interlaces of the feedback slot is associated with a maximum number of interlaces associated with a bandwidth and a subcarrier spacing.

In some embodiments, in response to the cast type of the transmission slot being the groupcast with the feedback of ACK or NACK and in response to a total number of multiple UEs in a group being greater than a maximum number of multiple feedback transmissions in the set of feedback resources, one or more UEs in the group not having an associated feedback resource will not perform a sidelink feedback transmission.

In some embodiments, a location of a feedback of the data transmission within the set of feedback resources in a time domain is associated with a location of the data transmission in the time domain, a sidelink PSFCH period configured to the UE, and a minimum time gap between the data transmission and the feedback slot configured to the UE.

In some embodiments, in response to the data transmission being located in multiple interlaces, a feedback transmission for the data transmission is located in a lowest interlace within the multiple interlaces in a frequency domain.

Some embodiments of the present application provide a method, which may be performed by a UE. The method includes: receiving configuration information for a sidelink transmission on an unlicensed band from a network; determining a feedback resource pattern on a feedback slot in response to a data transmission based on the configuration information; and determining a set of feedback resources on the feedback slot based on the feedback resource pattern.

Some embodiments of the present application also provide a network node (e.g., a base station (BS)). The network node includes a transceiver; and a processor coupled to the transceiver, wherein the processor is configured to transmit configuration information for a sidelink transmission on an unlicensed band via the transceiver to a user equipment (UE), wherein a feedback resource pattern on a feedback slot in response to a data transmission is determined by the UE based on the configuration information, and a set of feedback resources on the feedback slot is determined by the UE based on the feedback resource pattern.

In some embodiments, the configuration information includes at least one of: an indicator for enabling or disabling a resource pool or a time slot to support or not support the feedback resource pattern; a bitmap sequence to represent a mapping relationship between the feedback resource pattern and a slot index; one feedback resource pattern for a resource pool or a time slot within the resource pool; or multiple feedback resource patterns for the resource pool or the time slot.

In some embodiments, the feedback resource pattern in response to the data transmission is one feedback resource pattern within the multiple feedback resource patterns associated with at least one of a traffic type or a cast type of the transmission slot.

In some embodiments, a cast type of the data transmission is one of: a broadcast, a unicast, a groupcast with a feedback of negative acknowledgement (NACK) only, and a groupcast with a feedback of acknowledgement (ACK) or NACK.

In some embodiments, in response to the cast type of the data transmission being the groupcast with the feedback of only NACK or the groupcast with the feedback of ACK or NACK, the feedback resource pattern is associated with a total number of group members.

In some embodiments, in response to the set of feedback resources being with two or more physical sidelink feedback channels (PSFCHs) and in response to the cast type of the data transmission being the unicast or the groupcast with the feedback of only NACK, feedbacks of data transmissions in two or more slots are located in different symbol pairs in the set of feedback resources.

In some embodiments, in response to the cast type of the data transmission being the unicast or the groupcast with the feedback of only NACK, and in response to the data transmission being located in multiple interlaces: a total number of slots between the data transmission and the feedback slot in a time domain is associated with a sidelink PSFCH period and a minimum time gap between the data transmission and the feedback slot configured to the UE; and an interlace of a feedback of the data transmission within the set of feedback resources is a lowest interlace within the multiple interlaces in a frequency domain.

In some embodiments, in response to the cast type of the data transmission being the groupcast with the feedback of ACK or NACK, a feedback resource within the set of feedback resources for a feedback of the data transmission is associated with: a product of a first total number of physical sidelink feedback channels (PSFCHs) within the set of feedback resources in the feedback slot and a second total number of interlaces of the feedback slot; and a member identity (ID) number of a UE transmitting the feedback of the data transmission.

In some embodiments, the second total number of interlaces of the feedback slot is associated with a maximum number of interlaces associated with bandwidth and a subcarrier spacing.

In some embodiments, the set of feedback resources is located in no more than five PSFCHs in the feedback slot.

In some embodiments, a location of a feedback of the data transmission within the set of feedback resources in a time domain is associated with a location of the data transmission in the time domain, a sidelink PSFCH period configured to the UE, and a minimum time gap between the data transmission and the feedback slot configured to the UE.

In some embodiments, in response to the data transmission being located in multiple interlaces, a feedback transmission for the data transmission is located in a lowest interlace within the multiple interlaces in a frequency domain.

Some embodiments of the present application provide a method, which may be performed by a network node (e.g., a BS). The method includes: transmitting configuration information for a sidelink transmission on an unlicensed band to a user equipment (UE), wherein a feedback resource pattern on a feedback slot in response to a data transmission is determined by the UE based on the configuration information, and a set of feedback resources on the feedback slot is determined by the UE based on the feedback resource pattern.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned methods performed by a UE or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary V2X communication system in accordance with some embodiments of the present application.

FIG. 2 illustrates an exemplary flowchart of receiving configuration information for a sidelink transmission according to some embodiments of the present application.

FIGS. 3-7 illustrate exemplary feedback resource patterns according to some embodiments of the present application.

FIG. 8A illustrates an exemplary set of feedback resources according to some embodiments of the present application.

FIG. 8B illustrates exemplary transmissions of unicast and GC option 1 according to some embodiments of the present application.

FIG. 9 illustrates exemplary transmissions of unicast and GC option 2 according to some embodiments of the present application.

FIG. 10 illustrates an exemplary block diagram of a V2X apparatus according to some embodiments of the present application.

FIG. 11 illustrates a further exemplary block diagram of a V2X apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

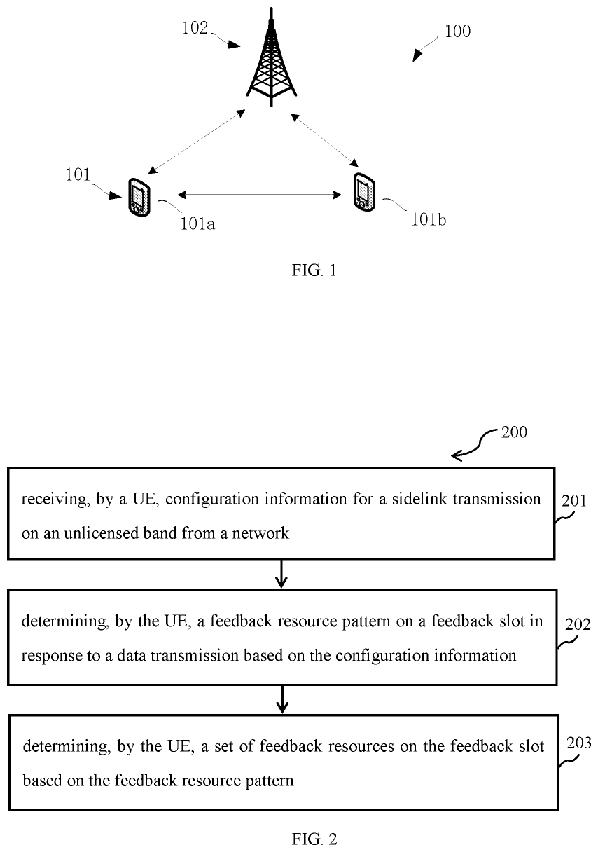

FIG. 1 illustrates an exemplary V2X communication system in accordance with some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, UE(s) 101 is pedestrian UE (P-UE or PUE) or cyclist UE. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via LTE or NR Uu interface.

In some embodiments of the present application, each of UE(s) 101 may be deployed an IoT application, an eMBB application and/or a URLLC application. For instance, UE 101a may implement an IoT application and may be named as an IoT UE, while UE 101b may implement an eMBB application and/or a URLLC application and may be named as an eMBB UE, an URLLC UE, or an eMBB/URLLC UE. It is contemplated that the specific type of application(s) deployed in UE(s) 101 may be varied and not limited.

In a V2X communication system, a transmission UE may also be named as a transmitting UE, a Tx UE, or a sidelink Tx UE. A reception UE may also be named as a receiving UE, an Rx UE, or a sidelink Rx UE.

According to some embodiments of FIG. 1, UE 101a functions as a Tx UE, and UE 101b functions as an Rx UE. UE 101a may exchange V2X messages with UE 101b through a sidelink, for example, PC5 interface as defined in 3GPP TS 23.303. UE 101a may transmit information or data to other UE(s) within the V2X communication system, through sidelink unicast, sidelink groupcast, or sidelink broadcast. For instance, UE 101a transmits data to UE 101b in a sidelink unicast session. UE 101a may transmit data to UE 101b and other UEs in a groupcast group (not shown in FIG. 1) by a sidelink groupcast transmission session. Also, UE 101a may transmit data to UE 101b and other UEs (not shown in FIG. 1) by a sidelink broadcast transmission session. Alternatively, according to some other embodiments of FIG. 1, UE 101b functions as a Tx UE and transmits V2X messages, and UE 101a functions as an Rx UE and receives the V2X messages from UE 101b.

Both UE 101a and UE 101b in the embodiments of FIG. 1 may transmit information to BS 102 and receive control information from BS 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 1102.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

In general, as defined in 3GPP TS38.213, a UE can be indicated by an SCI format scheduling a PSSCH, in one or more sub-channels from a number of N_{subch}^{PSSCH} sub-channels, to transmit a PSFCH with HARQ-ACK information in response to the PSSCH reception. PSFCH feedback in response to the PSSCH reception on one or more sub-channels may be ACK or NACK, or only NACK. The UE provides HARQ-ACK information that includes ACK or NACK, or only NACK in accordance with different cast types. ACK/NACK feedback may be for cast types of unicast and groupcast (GC) option 2, and only NACK feedback may be for a cast type of GC option 1. In addition, a UE can be provided, by periodPSFCHresource, a number of slots in a resource pool for a period of PSFCH transmission occasion resources. If the number is zero, PSFCH transmissions in the resource pool are disabled.

As defined in 3GPP TS38.331, sl-PSFCH-Period-r16 indicates the period of PSFCH resource in the unit of slots within this resource pool, and sl-PSFCH-Period-r16 is ENUMERATED {s10, sl1, sl2, sl4}, i.e., periodPSFCHresource={0, 1, 2, 4}. If set to sl0, no resource for PSFCH, and HARQ feedback for all transmissions in the resource pool is disabled. A UE may be indicated by higher layers to not transmit (i.e., disabling a feedback) a PSFCH in response to a PSSCH reception [11, TS 38.321]. If a UE receives a PSSCH in a resource pool and a ZYX field in a SCI format 0_2 scheduling the PSSCH reception indicates to the UE to report HARQ-ACK information for the PSSCH reception [5, TS 38.212], the UE provides the HARQ-ACK information in a PSFCH transmission in the resource pool. The UE transmits the PSFCH in a first slot that includes PSFCH resources and is at least a number of slots, provided by MinTimeGapPSFCH (i.e., time interval between transmitted PSCCH/PSSCH and PSFCH), of the resource pool after a last slot of the PSSCH reception.

As defined in 3GPP TS38.213, a sidelink control information (SCI) format 2-A includes a cast type indicator field. In particular, value “00” of the cast type indicator field represents a cast type “Broadcast”. Value “01” of the cast type indicator field represents a cast type “Groupcast when HARQ-ACK information includes ACK or NACK”. Value “10” of the cast type indicator field represents a cast type “Unicast”. Value “11” of the cast type indicator field represents a cast type “Groupcast when HARQ-ACK information includes only NACK”.

Based on legacy PSFCH resource configuration(s), for an interlace based sidelink (SL) slot with a feedback resource on an unlicensed band, only the PSFCH period “sl1” (i.e., periodPSFCHresource=1) can work well for cast types of unicast and groupcast (GC) option 1 (only NACK). For others SL PSFCH periods (e.g., s12 with “periodPSFCHresource=2” or sl4 with “periodPSFCHresource=4”) and a cast type of GC option 2 (ACK/NACK) (i.e., one transmission and multiple associated feedbacks from multiple users on separated resources), the feedback resource is not sufficient for interlace based transmission(s) on an unlicensed band.

Currently, there is no sidelink PSFCH resource allocation mechanism on an unlicensed band. Embodiments of the present application aim to solve the above-mentioned issues. Specifically, some embodiments of the present application define multiple feedback resource patterns for a resource pool or for a SL slot for an unlicensed band. Some embodiments of the present application define a feedback resource pattern for supporting various kinds of traffic well, i.e., cast types of unicast, GC option 1, and GC option 2. Some embodiments of the present application define behaviours of a Tx UE or an Rx UE for multiple feedback resource patterns. Some embodiments of the present application define contents of SCI to indicate a feedback resource pattern for an associated feedback slot. More details will be illustrated in the following text in combination with the appended drawings.

FIG. 2 illustrates an exemplary flowchart of receiving configuration information for a sidelink transmission according to some embodiments of the present application. The exemplary method 200 in FIG. 2 may be performed by a UE (e.g., UE 101 as shown in FIG. 1). Although described with respect to a UE, it should be understood that other devices may also be configured to perform the method as shown in FIG. 2.

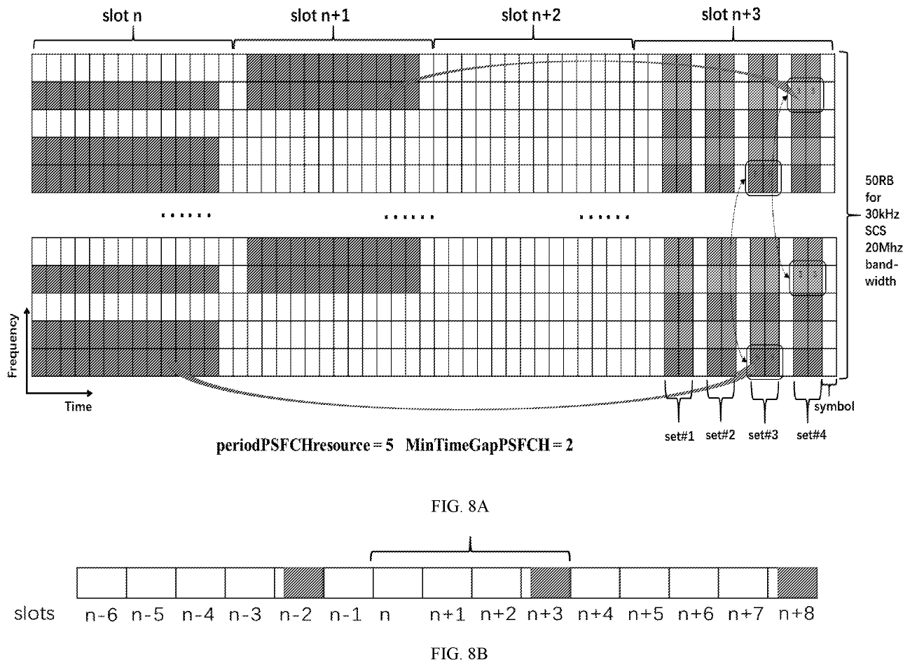

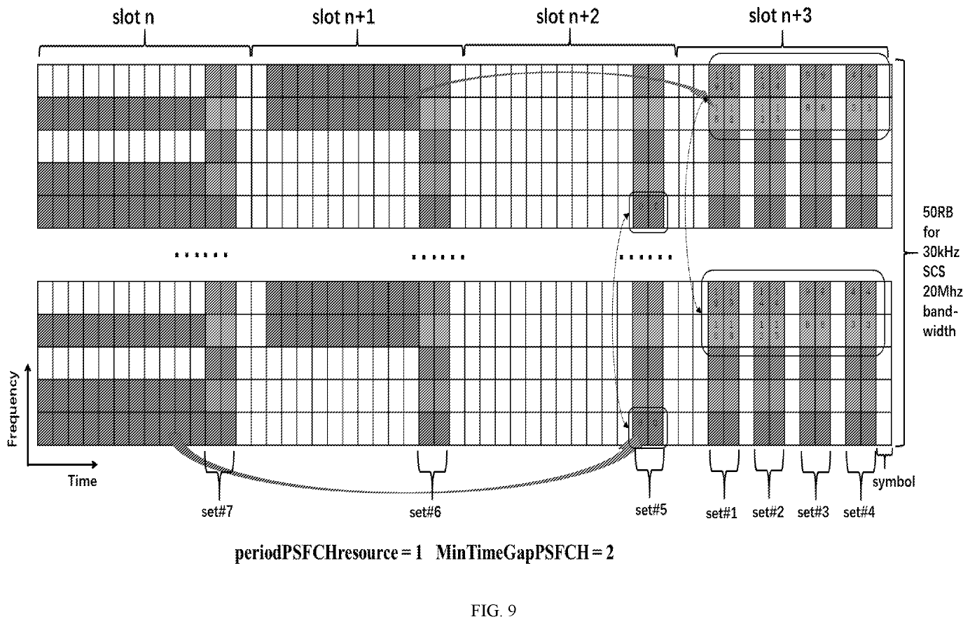

In the exemplary method 200 as shown in FIG. 2, in operation 201, a UE (e.g., UE 101 as shown in FIG. 1) receives configuration information for a sidelink transmission on an unlicensed band from a network (e.g., BS 102 as shown in FIG. 1). In operation 202, the UE determines a feedback resource pattern on a feedback slot in response to a data transmission based on the configuration information. In operation 203, the UE determines a set of feedback resources on the feedback slot based on the feedback resource pattern. In some embodiments, the configuration information includes at least one of:
(1) an indicator for enabling or disabling a resource pool or a time slot to support or not support the feedback resource pattern;
(2) a bitmap sequence to represent a mapping relationship between the feedback resource pattern and a slot index;
(3) one feedback resource pattern for a resource pool or a time slot within the resource pool; or
(4) multiple feedback resource patterns for the resource pool or the time slot. A specific example of a set of feedback resources corresponding to one feedback resource pattern is described in embodiments of FIG. 8A as follows. A specific example of a set of feedback resources corresponding to multiple feedback resource patterns is described in embodiments of FIG. 9 as follows.

In some embodiments, in response to the configuration information including the multiple feedback resource patterns for the resource pool or the time slot within the resource pool, the UE determines “one feedback resource pattern within the multiple feedback resource patterns” based on at least one of a traffic type or a cast type of the transmission slot, as the feedback resource pattern in response to the data transmission.

In some embodiments, the UE determines the feedback resource pattern based on a total number of group members, in response to a cast type of the data transmission being a groupcast with a feedback of only NACK (e.g., GC option 1), or a groupcast with a feedback of ACK or NACK (e.g., GC option 2). A specific example of a set of feedback resources for GC option 1 is described in embodiments of FIG. 8A. A specific example of a set of feedback resources for GC option 2 is described in embodiments of FIG. 9.

In some embodiments, the UE transmits or receives SCI, which includes a cast type indicator or a feedback resource pattern type index, over a sidelink. The cast type indicator or the feedback resource pattern type index indicates the feedback resource pattern. In an embodiment, the UE determines whether a cast type of the data transmission is a groupcast with a feedback of ACK or NACK (e.g., GC option 2) based on the SCI. In response to determining that the cast type is not the groupcast with a feedback of ACK or NACK (e.g., GC option 2), the UE does not exclude remaining symbols in the feedback slot except the set of feedback resources for a further data transmission.

In some embodiments, the UE determines whether a data transmission slot within a resource selection candidate resource set is monitored. In response to determining that the data transmission slot is not monitored, the UE excludes both the data transmission slot and a feedback transmission slot associated with the data transmission slot for the data transmission.

In some embodiments, the UE (i.e., an Rx UE, e.g., UE 101b as shown in FIG. 1) receives the data transmission over a sidelink, and transmits HARQ feedback information in response to a decoding state of the data transmission on the set of feedback resources over the sidelink.

In some other embodiments, the UE (i.e., a Tx UE, e.g., UE 101a as shown in FIG. 1) transmits the data transmission over a sidelink, and receives HARQ feedback information in response to a decoding state of the data transmission on the set of feedback resources over the sidelink.

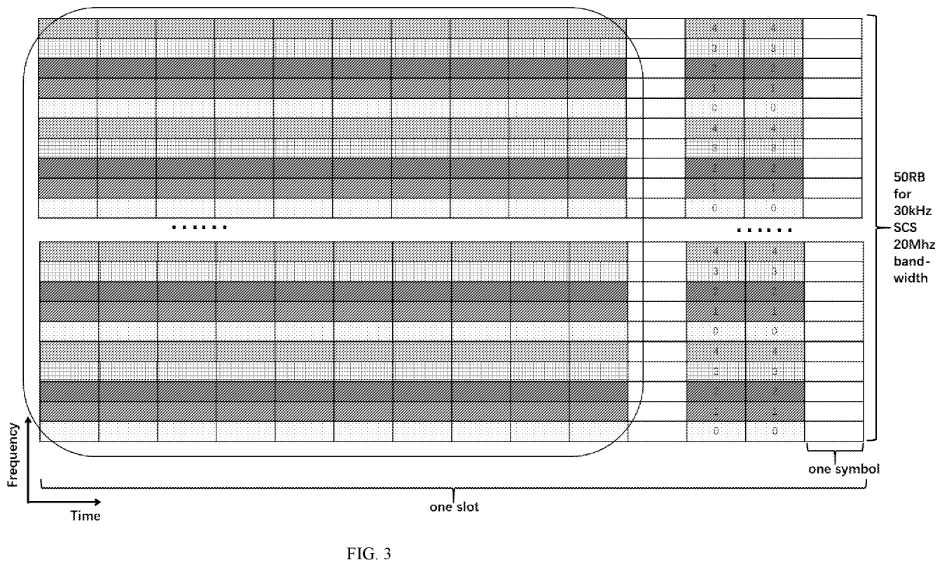

In some embodiments, the set of feedback resources is located in no more than five PSFCHs in the feedback slot. In some embodiments, the UE determines whether the set of feedback resources is with one to five PSFCHs. Each PSFCH within the one to five PSFCHs includes one symbol pair. In response to determining that the set of feedback resources is with one, two, or three PSFCHs, the UE excludes the one, two, or three PSFCHs within the feedback slot for a further data transmission. In response to determining that the set of feedback resources is with four or five PSFCHs, the UE excludes the feedback slot for a further data transmission. Specific examples of feedback resource patterns are described in embodiments of FIGS. 3-7 as follows.

In some embodiments, the UE determines a cast type of the data transmission. The cast type may be a broadcast, a unicast, a groupcast with a feedback of only NACK (e.g., GC option 1), or a groupcast with a feedback of ACK or NACK (e.g., GC option 2).

In an embodiment, in response to determining that the set of feedback resources is with two or more PSFCHs and in response to the cast type of the data transmission being the unicast or the groupcast with the feedback of only NACK (e.g., GC option 1), feedbacks of data transmissions in two or more slots are located in different symbol pairs in the set of feedback resources. A specific example is described in embodiments of FIG. 8A.

In an embodiment, in response to the cast type of the data transmission being the unicast or the groupcast with the feedback of only NACK (e.g., GC option 1), and in response to the data transmission being located in multiple interlaces: a total number of slots between the data transmission and the feedback slot in a time domain is associated with a sidelink PSFCH period (e.g., periodPSFCHresource) and a minimum time gap between the data transmission and the feedback slot (e.g., MinTimeGapPSFCH) configured to the UE; and an interlace of a feedback of the data transmission within the set of feedback resources is a lowest interlace within the multiple interlaces in a frequency domain. A specific example is described in embodiments of FIG. 8A.

In an embodiment, in response to the cast type of the data transmission being the groupcast with the feedback of ACK or NACK (e.g., GC option 2), the UE determines a total number of PSFCHs within the set of feedback resources in the feedback slot, determines a total number of interlaces of the feedback slot, computes a product of these two total numbers, and determines a feedback resource within the set of feedback resources for a feedback of the data transmission based on the product and a member identity (ID) number of a UE transmitting the feedback of the data transmission. In an embodiment, the total number of interlaces of the feedback slot is associated with a maximum number of interlaces associated with a bandwidth and a subcarrier spacing. A specific example is described in embodiments of FIG. 9.

In an embodiment, in response to the cast type of the transmission slot being the groupcast with the feedback of ACK or NACK (e.g., GC option 2) and in response to a total number of multiple UEs in a group being greater than a maximum number of multiple feedback transmissions in the set of feedback resources, one or more UEs in the group not having an associated feedback resource will not perform a sidelink feedback transmission.

In some embodiments, a location of a feedback of the data transmission within the set of feedback resources in a time domain is associated with a location of the data transmission in time domain, a sidelink PSFCH period (e.g., periodPSFCHresource) configured to the UE, and a minimum time gap between the data transmission and the feedback slot configured to the UE (e.g., MinTimeGapPSFCH).

In some embodiments, in response to the data transmission being located in multiple interlaces, a feedback transmission for the data transmission is located in a lowest interlace within the multiple interlaces in a frequency domain. A specific example is described in embodiments of FIG. 3 as follows.

It should be appreciated by persons skilled in the art that the sequence of the operations in exemplary procedure 200 may be changed and some of the operations in exemplary procedure 200 may be eliminated or modified, without departing from the spirit and scope of the disclosure. Details described in all other embodiments of the present application (for example, details regarding a feedback resource pattern) are applicable for the embodiments of FIG. 2. Moreover, details described in the embodiments of FIG. 2 are applicable for all the embodiments of FIGS. 1 and 3-12.

In addition, some embodiments of the present application provide an exemplary flowchart of a network node (e.g., a BS) transmitting configuration information for a sidelink transmission according to some embodiments of the present application. Although described with respect to a network node, it should be understood that other devices may be configured to perform a similar method.

It should be appreciated by persons skilled in the art that the sequence of the operations in this exemplary flowchart of a network node may be changed and some of the operations in this exemplary flowchart may be eliminated or modified, without departing from the spirit and scope of the disclosure. Details described in all other embodiments of the present application, e.g., in the embodiments of FIG. 2 are applicable for this exemplary flowchart. Moreover, details described in this exemplary flowchart are applicable for all the embodiments of FIGS. 1-12.

In particular, in this exemplary flowchart, a BS (e.g., BS 102 as shown in FIG. 1) transmits configuration information for a sidelink transmission on an unlicensed band to a UE (e.g., UE 101 as shown in FIG. 1). A feedback resource pattern on a feedback slot in response to a data transmission may be determined by the UE based on the configuration information. A set of feedback resources on the feedback slot may be determined by the UE based on the feedback resource pattern.

In some embodiments, the configuration information includes at least one of:
(1) an indicator for enabling or disabling a resource pool or a time slot to support or not support the feedback resource pattern;
(2) a bitmap sequence to represent a mapping relationship between the feedback resource pattern and a slot index;
(3) one feedback resource pattern for a resource pool or a time slot within the resource pool; or
(4) multiple feedback resource patterns for the resource pool or the time slot.

In an embodiment, the feedback resource pattern in response to the data transmission is one feedback resource pattern within the multiple feedback resource patterns associated with at least one of a traffic type or a cast type of the transmission slot. Specific examples of a set of feedback resources corresponding to one or more feedback resource patterns are described in embodiments of FIG. 8A and 9.

In some embodiments, a cast type of the data transmission is one of: a broadcast, a unicast, a groupcast with a feedback of only NACK (e.g., GC option 1), and a groupcast with a feedback of ACK or NACK (e.g., GC option 2).

In an embodiment, in response to the cast type of the data transmission being the groupcast with the feedback of only NACK (e.g., GC option 1) or the groupcast with the feedback of ACK or NACK (e.g., GC option 2), the feedback resource pattern is associated with a total number of group members. Specific examples of a set of feedback resources for GC option 1 or GC option 2 are described in embodiments of FIGS. 8A and 9.

In an embodiment, in response to the set of feedback resources being with two or more PSFCHs and in response to the cast type of the data transmission being the unicast or the groupcast with the feedback of only NACK (e.g., GC option 1), feedbacks of data transmissions in two or more slots are located in different symbol pairs in the set of feedback resources. A specific example is described in embodiments of FIG. 8A.

In an embodiment, in response to the cast type of the data transmission being the unicast or the groupcast with the feedback of only NACK (e.g., GC option 1), and in response to the data transmission being located in multiple interlaces: a total number of slots between the data transmission and the feedback slot in a time domain is associated with a sidelink PSFCH period and and a minimum time gap between the data transmission and the feedback slot configured to the UE; and an interlace of a feedback of the data transmission within the set of feedback resources is a lowest interlace within the multiple interlaces in a frequency domain. A specific example is described in embodiments of FIG. 8A.

In an embodiment, in response to the cast type of the data transmission being the groupcast with the feedback of ACK or NACK (e.g., GC option 2), a feedback resource within the set of feedback resources for a feedback of the data transmission is associated with: a product of a total number of PSFCHs within the set of feedback resources in the feedback slot and a total number of interlaces of the feedback slot; and a member ID number of a UE transmitting the feedback of the data transmission. For instance, the total number of interlaces of the feedback slot is associated with a maximum number of interlaces associated with bandwidth and a subcarrier spacing. A specific example is described in embodiments of FIG. 9.

In some embodiments, the set of feedback resources is located in no more than five PSFCHs in the feedback slot.

In some embodiments, a location of a feedback of the data transmission within the set of feedback resources in a time domain is associated with a location of the data transmission in time domain, a sidelink PSFCH period (e.g., periodPSFCHresource) configured to the UE, and a minimum time gap between the data transmission and the feedback slot (e.g., MinTimeGapPSFCH) configured to the UE.

In some embodiments, in response to the data transmission being located in multiple interlaces, a feedback transmission for the data transmission is located in a lowest interlace within the multiple interlaces in a frequency domain. A specific example is described in embodiments of FIG. 3.

Some embodiments of the present application define multiple feedback resource patterns for a resource pool or for a SL slot for an unlicensed band. In particular, a network may configure feedback resource pattern(s) for a resource pool or for a SL slot within the resource pool, e.g., feedback resource pattern(s) in an interlace-based SL slot with feedback resource(s).

For instance, for 15 kHz SCS (subcarrier spacing), 20 Mhz bandwidth comprises 10 interlaces with 10/11 PRBs per interlace. For 30 kHz SCS (subcarrier spacing), 20 Mhz bandwidth comprises 5 interlaces with 10 or 11 physical resource blocks (PRBs) per interlace.

FIGS. 3-7 illustrate exemplary feedback resource patterns according to some embodiments of the present application. In embodiments of FIGS. 3-7, feedback resource patterns are for 30 kHz SCS with 20 Mhz bandwidth and include 50 resource blocks (RBs) in frequency domain. It can be contemplated that these feedback resource patterns may also be applied to different SCS with different bandwidths, and the total number of RBs may vary in different embodiments, without departing from the spirit and scope of the disclosure.

FIG. 3 shows a feedback resource pattern in an interlace-based SL slot with feedback resource(s) (named as Pattern 0 for simplicity). As shown in FIG. 3, one slot includes 14 symbols in total in time domain, and includes 50 RBs in total in frequency domain for 30 kHz SCS with 20 Mhz bandwidth. It can be contemplated that Pattern 0may also be applied to different SCS with different bandwidths, without departing from the spirit and scope of the disclosure. That is, Pattern 0 may include more or less RBs in frequency domain.

As shown in FIG. 3, 50 RBs correspond to 5 interlaces. For example, RBs marked with 0 belong to interlace#0, RBs marked with 1 belong to interlace#1, RBs marked with 2 belong to interlace#2, RBs marked with 3 belong to interlace#3, and RBs marked with 4 belong to interlace#4. Pattern 1 includes one PSFCH in the slot that includes one symbol pair for transmitting a feedback in response to a data transmission. Other symbols in the slot are used for transmitting data transmission(s). Feedback resources in the PSFCH are marked with 0˜4, i.e., feedback resource 0, 1, 2, 3, or 4 as shown in FIG. 3.

Pattern 0 can be used for “periodPSFCHresource=1”. The feedback resource at “slot n+MinTimeGapPSFCH” is used for a feedback transmission in response to a data transmission at “slot n” in time domain. Feedback resource 0 may be used for the feedback transmission in response to a data transmission at least using interlace#0 in frequency domain. For example, the UE may use interlace#0, interlace#1, and interlace#3, and the interlace#0 is the lowest interlace index of used interlace. A set of feedback resource is corresponding to a set of data resource based on interlace index. The PSFCH resource and the index of PSFCH resource is corresponding to the lowest index (in frequency domain) of the data transmission.

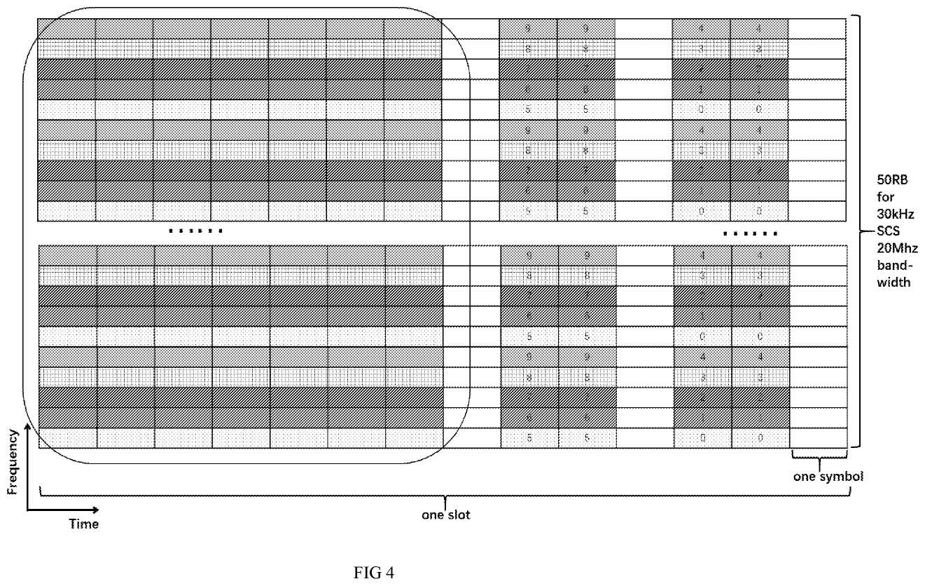

FIG. 4 shows a further feedback resource pattern in an interlace-based SL slot with feedback resource(s) (named as Pattern 1 for simplicity). Similar to FIG. 3, Pattern 1 also includes 50 RBs corresponding to 5 interlaces in frequency domain. Different from Pattern 0 in FIG. 3, Pattern 1 includes two PSFCHs in the slot that includes two symbol pairs for transmitting a feedback in response to a data transmission. Other symbols in the slot are used for transmitting data transmission(s). Feedback resources in these two PSFCHs are marked with 0˜4 (i.e., feedback resource 0, 1, 2, 3, or 4 as shown in FIGS. 4) and 5˜9 (i.e., feedback resource 5, 6, 7, 8, or 9 as shown in FIG. 4), respectively. Pattern 1may be used for SL PSFCH periods sl2, unicast and GC option 1 (only NACK) and GC option 2 (ACK/NACK) with 10 member UEs.

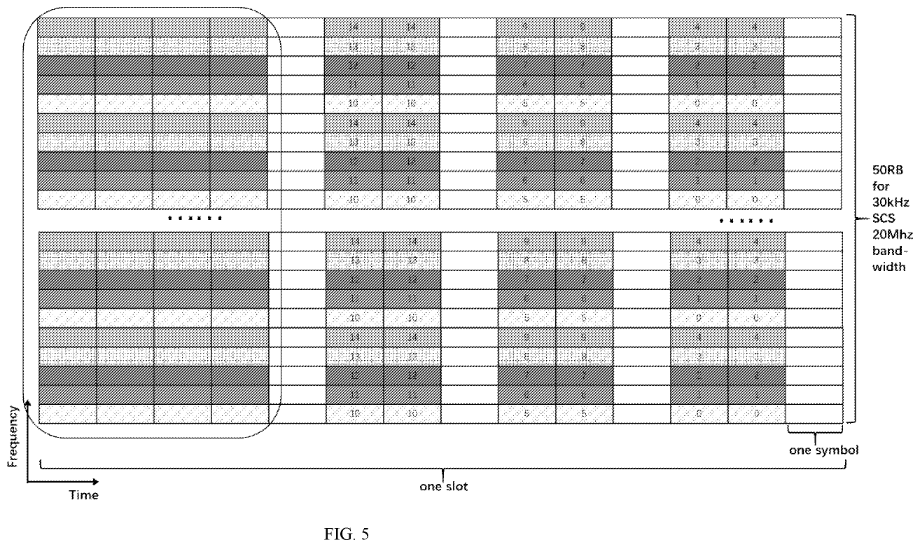

FIG. 5 shows another feedback resource pattern in an interlace-based SL slot with feedback resource(s) (named as Pattern 2 for simplicity). Similar to FIG. 3, Pattern 2 also includes 50 RBs corresponding to 5 interlaces in frequency domain. Different from Pattern 0 in FIG. 3, Pattern 2 includes three PSFCHs in the slot that includes three symbol pairs for transmitting a feedback in response to a data transmission. Other symbols in the slot are used for transmitting data transmission(s). Feedback resources in these three PSFCHs are marked with 0˜4 (i.e., feedback resource 0, 1, 2, 3, or 4 as shown in FIG. 5), 5˜9 (i.e., feedback resource 5, 6, 7, 8, or 9 as shown in FIGS. 5), and 10˜14 (i.e., feedback resource 10, 11, 12, 13, or 14 as shown in FIG. 5), respectively. Pattern 2 may be used for SL PSFCH periods sl2, unicast and GC option 1 (only NACK), and GC option 2(ACK/NACK) with 15 member UEs.

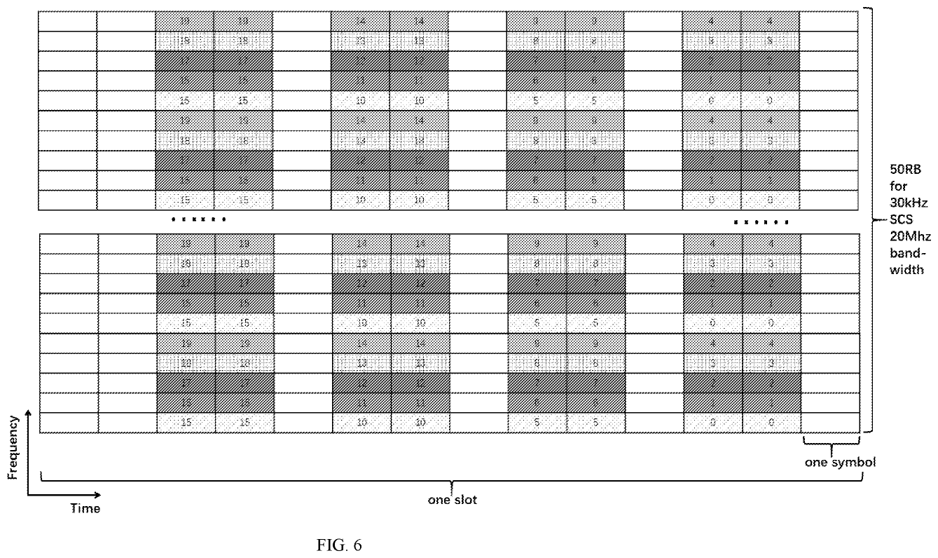

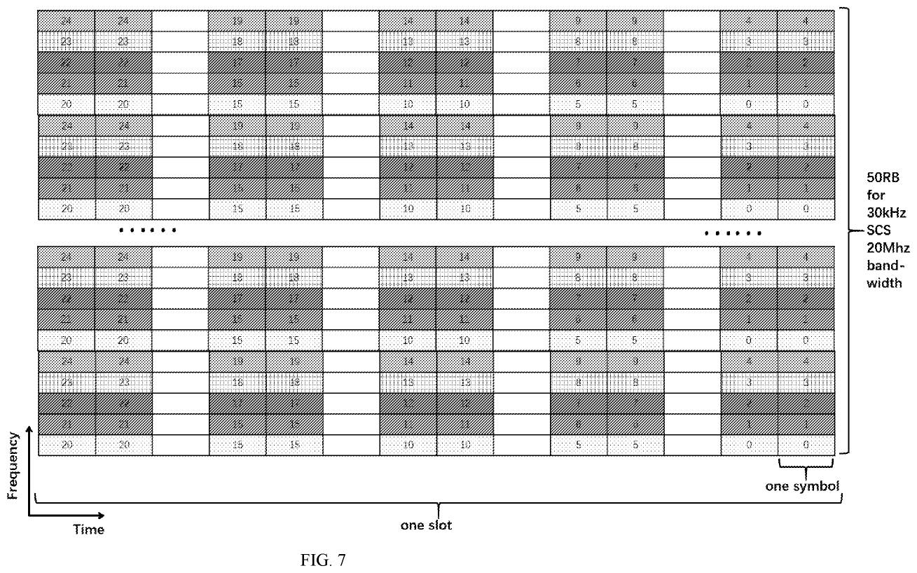

FIGS. 6 and 7 show yet another feedback resource patterns in an interlace-based SL slot with feedback resource(s) (named as Pattern 3 and Pattern 4 for simplicity). Similar to FIG. 3, Pattern 3 in FIG. 6 and Pattern 4 in FIG. 7 also include 50 RBs corresponding to 5 interlaces in frequency domain. Different from Pattern 0 in FIG. 3, Pattern 3 in FIG. 6 includes four PSFCHs in the slot that includes four symbol pairs for transmitting a feedback in response to a data transmission, and Pattern 4 in FIG. 7 includes five PSFCHs in the slot that includes five symbol pairs for transmitting a feedback in response to a data transmission. No symbol in the slot in FIG. 6 or FIG. 7 is used for transmitting a data transmission. Feedback resources in PSFCHs in Pattern 3 in FIG. 6 are marked with 0˜19, respectively. Pattern 3 may be used for SL PSFCH periods sl4, unicast and GC option 1 (only NACK), and GC option 2 (ACK/NACK) with 20 member UEs. Feedback resources in PSFCHs in Pattern 4 in FIG. 7 are marked with 0˜24, respectively. Pattern 4 may be used for SL PSFCH periods sl4, unicast and GC option 1 (only NACK), and GC option 2 (ACK/NACK) with 25 member UEs.

Patterns 0˜4 as shown in FIGS. 3-7 may be used for transmitting feedback(s) in response to data transmission(s) in different cases. Following text describes embodiments of FIGS. 8A-10 which use Pattern 3 in FIG. 6 for an exemplary purpose.

In some embodiments, a total number of feedback resources in a feedback slot, i.e., the maximum number of UEs in a group for GC option 2, is associated with a total number of interlaces. For example, for Pattern 3 in FIG. 6, 40 UEs can be supported for 15 kHz SCS, and 20 UEs can be supported for 30 kHz SCS. If the total number of UEs in a group is larger than the maximum number of UEs, the UE without associated feedback resource(s) will not perform a SL feedback transmission.

For example, if “N” represents a total number of PSSCH slots associated with a single PSFCH slot, N may be calculated as “N=periodPSFCHresource−1” for Pattern 3 in FIG. 6 and Pattern 4 in FIG. 7 and “N=periodPSFCHresource” for Pattern 0, Pattern 1, and Pattern 2. If “S” represents a total number of interlaces in frequency domain, a total number of feedback resources (PSFCH resources) may be calculated as the product of S and N, i.e., S*N. Based on this, it can be determined that for Pattern 3 in FIG. 6, at most 40 UEs can be supported for 15 kHz SCS, and at most 20 UEs can be supported for 30 kHz SCS.

In some embodiments, if there are more than 40 UEs in a group for GC option 2 for 15 kHz SCS, other UE(s) except UE#0 to UE#39 does not have associated feedback resource(s) and will not perform a SL feedback transmission in the feedback slot. In some other embodiments, if there are more than 20 UEs in a group for GC option 2 for 30 kHz SCS, other UE(s) except UE#0 to UE#19 does not have associated feedback resource(s) and will not perform a SL feedback transmission in the feedback slot.

FIG. 8A illustrates an exemplary set of feedback resources according to some embodiments of the present application. FIG. 8A shows four interlace based SL slots in time domain, i.e., slot n, slot n+1, slot n+2, and slot n+3. Slot n+3 corresponds to Pattern 3 in FIG. 6 with 4 sets of feedback resources (which may also be named as 4 PSFCHs or four symbol pairs), i.e., set#1, set#2, set#3, and set#4 as shown in FIG. 8A.

Some embodiments of FIG. 8A refer to transmissions of unicast and GC option 1, e.g., as shown in FIG. 8B. Some other embodiments of FIG. 8A refer to transmissions of unicast, GC option 1, and GC option 2.

FIG. 8B illustrates exemplary transmissions of unicast and GC option 1 according to some embodiments of the present application. The embodiments of FIG. 8B assume “periodPSFCHresource=5” and “MinTimeGapPSFCH=2”. FIG. 8B shows slot n−6 to slot n+8, wherein slots n−2, n+3, and n+8 may be used for transmitting feedback transmissions. That is, slots n−2, n+3, and n+8 are feedback slots. Other slots in FIG. 8B may be used for transmitting data transmissions. Details of “slot n” to “slot n+3” in FIG. 8B are shown in FIG. 8A.

Specifically, as shown in FIG. 8A, set#3 of feedback resource at slot n+3 is used for a feedback transmission in response to a data transmission at slot n. RBs marked with 5 in set#3 (named as feedback resource 5 for simplicity) belong to interlace#0. In some embodiments, feedback resource 5 is used for the feedback transmission in response to the data transmission at least using interlace#0 in frequency domain. For example, if a UE uses interlace#0, interlace#1, and interlace#3 to transmit the data transmission at slot n, interlace#0 is the lowest interlace index of used interlaces. Thus, the feedback transmission in response to the data transmission at slot n is transmitted in feedback resource 5 in interlace#0.

Set#4 of feedback resource at slot n+3 is used for a feedback transmission in response to a data transmission at slot n+1 in time domain. RBs marked with 3 in set#4 (named as feedback resource 3 for simplicity) belong to interlace#3. In some embodiments, feedback resource 3 is used for the feedback transmission in response to the data transmission at least using interlace#3 in frequency domain. For example, if a UE uses interlace#3 and interlace#4 to transmit the data transmission at slot n+1 in time domain, interlace#3 is the lowest interlace index of used interlaces. Thus, the feedback transmission in response to the data transmission at slot n+1 is transmitted in feedback resource 3 with interlace#3 in frequency domain.

As shown in FIG. 8A, 50 RBs includes 5 interlaces, each interlace includes 10 RBs. Thus, set#3 includes ten feedback resources 5 in total, and set#4 includes ten feedback resources 3 in total. Two feedback resources 5 as shown in FIG. 8A and eight feedback resources 5 (not shown in FIG. 8A) transmit the same feedback transmission in response to the data transmission at slot n. Similarly, ten feedback resources 3 (in which eight feedback resources 3 not shown in FIG. 8A) are used for transmitting the same feedback transmission in response to the data transmission at slot n+1.

In addition, set#2 of feedback resource at slot n+3 is used for a feedback transmission in response to a data transmission at slot n−1 in time domain. Set#1 of feedback resource at slot n+3 is used for data transmission at slot n−3 in time domain, the feedback resource used for feedback transmissions in response to data transmission at slot n+2 may be allocated at set#1 at slot n+8 (n+3+periodPSFCHresource).

FIG. 9 illustrates exemplary transmissions of unicast, GC option 1, and GC option 2 according to some embodiments of the present application. The embodiments of FIG. 9 assume “periodPSFCHresource=1” and “MinTimeGapPSFCH=2”.

As shown in FIG. 9, for unicast and GC option 1, feedback resources at slot n+2 is used for a feedback transmission in response to the data transmission at slot n in time domain. Feedback resource 0 in set#5 is used for the feedback transmission in response to the data transmission at least using interlace#0 in frequency domain. For example, a UE may use interlace#0, interlace#1, and interlace#3, and interlace#0 is the lowest interlace index of used interlaces. Thus, the feedback transmission in response to the data transmission at slot n is transmitted in feedback resource 0 in interlace#0. Similarly, feedback resources in set#6 and set#7 may be used for feedback transmissions in response to data transmissions at two slots before slot n in time domain.

In some embodiments of FIG. 9 for GC option 2, for PSFCH candidate resources (e.g., set#1 to set#4 as shown in FIG. 9), the mapping between Rx UEs and PSFCH resources may be defined as follows. For instance, a PSFCH resource with the index ((K+M) mod (Z*Y)) is used for a feedback transmission of an RX UE.
(1) Z is a total number of interlaces in the PSFCH candidate resource set (e.g., Z=5 as shown in FIG. 9).
(2) Y is a total number of symbol pairs in the PSFCH candidate resource set (e.g., Z=4 as shown in FIG. 9).
(3) K is a source ID of the associated PSCCH or PSSCH; or K=0.
(4) M is 0 for unicast and GC option 1; and M is the member ID of the Rx UE for GC option 2.

If a total number of member UEs in a group for GC option 2 is X, and if X is greater than the product of Z and Y, i.e., X >Z*Y, only Rx UEs with member ID (i.e., M) from 0 and X−1 may use PSFCH candidate resources in the set for feedback transmission, while other Rx UEs cannot use PSFCH candidate resources in the set for feedback transmission.

For instance, as shown in FIG. 9, for GC option 2, the feedback resources at slot n+3 are used for a feedback transmission in response to the data transmission at slot n+1 in time domain. Feedback resources in set#1 to set#4 (i.e., PSFCH resources with index 3, 4, 8, 9, 13, 14, 18, and 19) are used for feedback transmissions from multiple UEs in response to the data transmission at least using interlace 3 in frequency domain. For example, a Tx UE may use interlace#3 and interlace#4, and interlace#3 is the lowest interlace index of used interlaces. Here, feedback resources 3, 4, 8, 9, 13, 14, 18, 19 are used by eight Rx UEs in a group in total, e.g., Rx UEs with group member ID M being equal to 0, 1, 2, 3, 4, 5, 6, and 7, respectively.

In some embodiments of the present application, a network may configure various feedback resource pattern types, for a resource pool or a SL slot within the resource pool. i.e., the resource pool or the slot can use Pattern 0, Pattern 1, Pattern 2, Pattern 3, and/or Pattern 4 as shown in FIGS. 3-7. One specific example may refer to FIG. 9.

In an embodiment, a network may configure to a UE an indicator for enabling or disabling a resource pool or a time slot to support one or more feedback resource patterns, e.g., Pattern 0, Pattern 1, Pattern 2, Pattern 3, and/or Pattern 4 as shown in FIGS. 3-7. In an embodiment, a network may transmit resource pool configuration(s), which includes a bitmap sequence to represent a mapping relationship between the feedback resource pattern and a slot index (e.g., a physical slot or a logic slot), to a UE, to indicate enabling or disabling feedback resource pattern(s) for the slot(s).

In an embodiment, resource pool configuration(s) includes a bitmap sequence to indicate indexes of feedback slots for which Pattern 0 is enabled (e.g., a physical slot or a logic slot). Further resource pool configuration(s) additionally includes a further bitmap sequence to indicate indexes of feedback slots for which Patterns 1, 2, 3, and 4 besides Pattern 0 are enabled.

In an embodiment, a UE can determine one feedback resource pattern from configured multiple feedback resource patterns for a certain time slot based on its transmission cast type. For example, with reference to FIG. 9, multiple feedback resource patterns are configured for a resource pool or a time slot. As shown in FIG. 9, each slot is indicated to enable Pattern 0 and Pattern 3. When the data transmission at slot n is unicast or GC option 1, a Tx UE or a data transmission UE can determine that Pattern 0 is used at slot n+2. When the transmission at slot n+1 is GC option 2, the Tx UE or the data transmission UE can determine that Pattern 3 is used at slot n+3. The Tx UE or the data transmission UE can further determine the feedback resource pattern type of the feedback slot (e.g., slot n+3) based on its traffic or cast type. There may be following different embodiments in different scenarios.

In some embodiments, if various feedback resource patterns are configured or enabled to a resource pool or a time slot, a Tx UE may transmit a cast type indicator in SCI for a data transmission of GC option 2, to implicitly indicate that: (1) a feedback resource pattern type on associated feedback slot is Pattern 1 or 2 or 3 or 4 based on configuration information for the Tx UE; and (2) the feedback slot is reserved for feedback transmissions for multiple UEs. An Rx UE or a data reception UE will transmit a feedback in response to the received data transmission on a feedback resource based on the feedback resource pattern and the number ID of the Rx UE or the data reception UE.

In some embodiments, if various feedback resource patterns are configured or enabled to a resource pool or a time slot, a sensing UE may exclude some transmission resource(s) for future data transmission(s), i.e., not transmit data on the excluded transmission resource(s). For example, a sending UE may:
(1) exclude the feedback slot for future data transmission(s), when the feedback resource pattern is Pattern 3 or 4; or
(2) exclude the feedback transmission resources at that feedback slot for future data transmission(s), when the feedback resource pattern is Pattern 1 or 2; or
(3) exclude the feedback slot whose associated data transmission slot has not been monitored for future data transmission(s). For example, in FIG. 8A, if the sensing UEs does not perform sensing at slot n (i.e., not performing SL transmission), from a periodic reservation point of view, the sensing UE will exclude slot n and its associated feedback slot n+3 from a resource selection candidate resource set for future data transmission(s).

In some embodiments, if various feedback resource patterns are configured to a resource pool or a time slot and if the cast type indicator in SCI for data transmission is not GC option 2, an Rx UE or a sensing UE can use the feedback slot for its future data transmission.

In some embodiments, if one or more feedback resource patterns are configured or enabled to a resource pool or a time slot, a Tx UE may determine one within the one or more feedback resource patterns based on a total number of group members, and indicate the feedback resource pattern type index in its SCI. This SCI is used to indicate the associated data and feedback transmission. That is, an indicator is included in SCI to indicate the pattern type for its feedback slot.

Details described in all other embodiments of the present application (for example, details regarding a sidelink feedback resource allocation mechanism) are applicable for the embodiments of FIGS. 3-9. Moreover, details described in the embodiments of FIGS. 3-9 are applicable for all the embodiments of FIGS. 1, 2, 10, and 11.

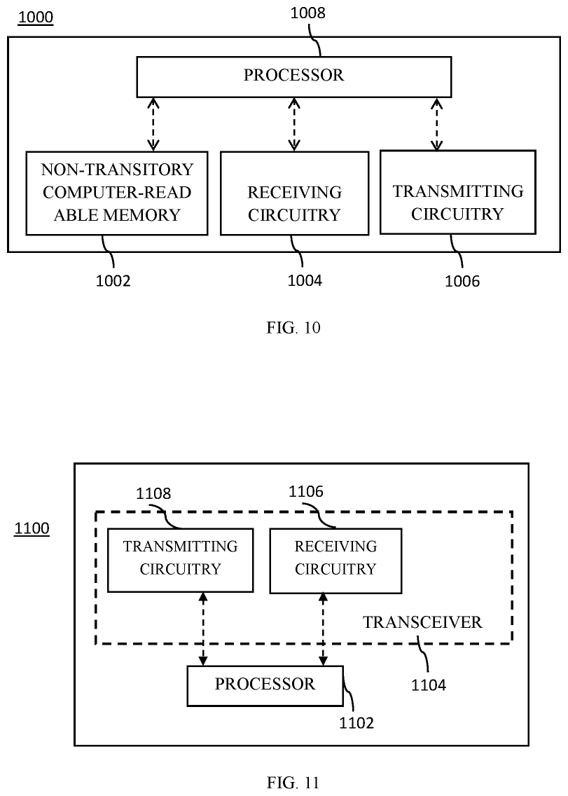

FIG. 10 illustrates an exemplary block diagram of a V2X apparatus 1000 according to some embodiments of the present application. As shown in FIG. 10, the apparatus 1000 may include at least one non-transitory computer-readable medium 1002, at least one receiving circuitry 1004, at least one transmitting circuitry 1006, and at least one processor 1008 coupled to the non-transitory computer-readable medium 1002, the receiving circuitry 1004 and the transmitting circuitry 1006. The at least one processor 1008 may be a CPU, a DSP, a microprocessor etc. The apparatus 1000 may be a network node (e.g., a BS) or a UE configured to perform a method illustrated in the above or the like.

Although in this figure, elements such as the at least one processor 1008, receiving circuitry 1004, and transmitting circuitry 1006 are described in the singular, the plural is contemplated unless a limitation to the singular is explicitly stated. In some embodiments of the present application, the receiving circuitry 1004 and the transmitting circuitry 1006 can be combined into a single device, such as a transceiver. In certain embodiments of the present application, the apparatus 1000 may further include an input device, a memory, and/or other components.

In some embodiments of the present application, the non-transitory computer-readable medium 1002 may have stored thereon computer-executable instructions to cause a processor to implement the methods with respect to a UE or a network node (e.g., a BS) as described or illustrated above. For example, the computer-executable instructions, when executed, cause the processor 1008 interacting with receiving circuitry 1004 and transmitting circuitry 1006, so as to perform the steps with respect to a UE or a network node (e.g., a BS) as described or illustrated above.

FIG. 11 illustrates a further exemplary block diagram of a V2X apparatus 1100 according to some embodiments of the present application. Referring to FIG. 11, the apparatus 1100, for example a BS or a UE, may include at least one processor 1102 and at least one transceiver 1104 coupled to the at least one processor 1102. The transceiver 1104 may include at least one separate receiving circuitry 1106 and transmitting circuitry 1108, or at least one integrated receiving circuitry 1106 and transmitting circuitry 1108. The at least one processor 1102 may be a CPU, a DSP, a microprocessor etc.

According to some other embodiments of the present application, when the apparatus 1100 is a UE, the processor 1102 may be configured: to receive configuration information for a sidelink transmission on an unlicensed band via the transceiver 1104 from a network; to determine a feedback resource pattern on a feedback slot in response to a data transmission based on the configuration information; and to determine a set of feedback resources on the feedback slot based on the feedback resource pattern.

According to some embodiments of the present application, when the apparatus 1100 is a network node (e.g., a BS), the processor 1102 is configured to transmit configuration information for a sidelink transmission on an unlicensed band via the transceiver 1104 to a user equipment (UE), wherein a feedback resource pattern on a feedback slot in response to a data transmission is determined by the UE based on the configuration information, and a set of feedback resources on the feedback slot is determined by the UE based on the feedback resource pattern.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive configuration information for a sidelink transmission on an unlicensed band from a network;
determine a feedback resource pattern on a feedback slot in response to a data transmission based on the configuration information; and
determine a set of feedback resources on the feedback slot based on the feedback resource pattern.

2. The UE of claim 1, wherein the configuration information includes at least one of:
an indicator for enabling or disabling a resource pool or a time slot to support or not support the feedback resource pattern;
a bitmap sequence to represent a mapping relationship between the feedback resource pattern and a slot index;
one feedback resource pattern for a resource pool or a time slot within the resource pool; or
multiple feedback resource patterns for the resource pool or the time slot.

3. The UE of claim 2, wherein, in response to the configuration information including the multiple feedback resource patterns for the resource pool or the time slot, to determine the feedback resource pattern, the at least one processor is configured to cause the UE to determine one feedback resource pattern within the multiple feedback resource patterns based on at least one of a traffic type or a cast type of a transmission slot, as the feedback resource pattern in response to the data transmission.

4. The UE of claim 1, wherein, to determine the feedback resource pattern, the at least one processor is configured to cause the UE to determine the feedback resource pattern based on a total number of group members, in response to a cast type of the data transmission being a groupcast with a feedback of only negative acknowledgement (NACK), or a groupcast with a feedback of acknowledgement (ACK) or NACK.

5. The UE of claim 1, wherein the at least one processor is configured to cause the UE to transmit or receive sidelink control information (SCI) over a sidelink, wherein the SCI includes a cast type indicator or a feedback resource pattern type index, and wherein the cast type indicator or the feedback resource pattern type index indicates the feedback resource pattern.

6. The UE of claim 5, wherein the at least one processor is configured to cause the UE to:
determine whether a cast type of the data transmission is a groupcast with a feedback of acknowledgement (ACK) or negative acknowledgement (NACK) based on the SCI; and
in response to determining that the cast type of the data transmission is not the groupcast with a feedback of ACK or NACK, not exclude remaining symbols in the feedback slot except the set of feedback resources for a second data transmission.

7. The UE of claim 1, wherein the at least one processor is configured to cause the UE to:
determine whether a data transmission slot within a resource selection candidate resource set is monitored; and
in response to determining that the data transmission slot is not monitored, exclude both the data transmission slot and a feedback transmission slot associated with the data transmission slot for the data transmission.

8. The UE of claim 1, wherein the set of feedback resources is located in no more than five PSFCHs in the feedback slot.

9. The UE of claim 8, wherein the at least one processor is configured to cause the UE to:
determine whether the set of feedback resources is with one to five physical sidelink feedback channels (PSFCHs), wherein each PSFCH within the one to five PSFCHs includes one symbol pair;
in response to determining that the set of feedback resources is with one, two, or three PSFCHs, exclude the one, two, or three PSFCHs within the feedback slot for a second data transmission; and
in response to determining that the set of feedback resources is with four or five PSFCHs, exclude the feedback slot for the second data transmission.

10. A network node, comprising:
at least one memory; and
at least one processor coupled with the at least one memory and configured to cause the network node to:
transmit configuration information for a sidelink transmission on an unlicensed band to a user equipment (UE), wherein a feedback resource pattern on a feedback slot in response to a data transmission is determined by the UE based on the configuration information, and a set of feedback resources on the feedback slot is determined by the UE based on the feedback resource pattern.

11. The network node of claim 10, wherein the configuration information includes at least one of:
an indicator for enabling or disabling a resource pool or a time slot to support or not support the feedback resource pattern;
a bitmap sequence to represent a mapping relationship between the feedback resource pattern and a slot index;
one feedback resource pattern for a resource pool or a time slot within the resource pool; or
multiple feedback resource patterns for the resource pool or the time slot.

12. The network node of claim 10, wherein a cast type of the data transmission is one of: a broadcast, a unicast, a groupcast with a feedback of only negative acknowledgement (NACK), and a groupcast with a feedback of acknowledgement (ACK) or NACK.

13. The network node of claim 12, wherein in response to the cast type of the data transmission being the unicast or the groupcast with the feedback of only NACK, and in response to the data transmission being located in multiple interlaces:
a total number of slots between the data transmission and the feedback slot in a time domain is associated with a sidelink PSFCH period and a minimum time gap between the data transmission and the feedback slot configured to the UE; and
an interlace of a feedback of the data transmission within the set of feedback resources is a lowest interlace within the multiple interlaces in a frequency domain.

14. The network node of claim 12, wherein in response to the cast type of the data transmission being the groupcast with the feedback of ACK or NACK, a feedback resource within the set of feedback resources for a feedback of the data transmission is associated with:
a product of a first total number of physical sidelink feedback channels (PSFCHs) within the set of feedback resources in the feedback slot and a second total number of interlaces of the feedback slot; and
a member identity (ID) number of a UE transmitting the feedback of the data transmission.

15. A method performed by a user equipment (UE), the method comprising:
receiving configuration information for a sidelink transmission on an unlicensed band from a network;
determining a feedback resource pattern on a feedback slot in response to a data transmission based on the configuration information; and
determining a set of feedback resources on the feedback slot based on the feedback resource pattern.

16. The method of claim 15, wherein the configuration information includes at least one of:
an indicator for enabling or disabling a resource pool or a time slot to support or not support the feedback resource pattern;
a bitmap sequence to represent a mapping relationship between the feedback resource pattern and a slot index;
one feedback resource pattern for a resource pool or a time slot within the resource pool; or
multiple feedback resource patterns for the resource pool or the time slot.

17. The method of claim 16, wherein, in response to the configuration information including the multiple feedback resource patterns for the resource pool or the time slot, to determine the feedback resource pattern, the method further comprises determining one feedback resource pattern within the multiple feedback resource patterns based on at least one of a traffic type or a cast type of a transmission slot, as the feedback resource pattern in response to the data transmission.

18. The method of claim 15, wherein, to determine the feedback resource pattern, the method further comprises determining the feedback resource pattern based on a total number of group members, in response to a cast type of the data transmission being a groupcast with a feedback of only negative acknowledgement (NACK), or a groupcast with a feedback of acknowledgement (ACK) or NACK.

19. The method of claim 15, further comprising transmitting or receiving sidelink control information (SCI) over a sidelink, wherein the SCI includes a cast type indicator or a feedback resource pattern type index, and wherein the cast type indicator or the feedback resource pattern type index indicates the feedback resource pattern.

20. A processor for wireless communication, comprising:
at least one controller coupled with at least one memory and configured to cause the processor to:
receive configuration information for a sidelink transmission on an unlicensed band from a network;
determine a feedback resource pattern on a feedback slot in response to a data transmission based on the configuration information; and
determine a set of feedback resources on the feedback slot based on the feedback resource pattern.
